(19) United States
(12) Patent Application Publication
(10) Pub. No.: US 2005/0257830 A1
(43) Pub. Date: Nov. 24, 2005

(54) Float valve assembly

(76) Inventor: James J. Nonnie, Joliet, IL (US)

Correspondence Address: MCDERMOTT, WILL & EMERY LLP, 227 WEST MONROE STREET, CHICAGO, IL, 60606-5096, US

(21) Appl. No.: 11/133,068

(22) Filed: May 19, 2005

Related U.S. Application Data
(60) Provisional application No. 60/572,626, filed on May 19, 2004.

(51) Int. Cl. G05D 9/00

(52) U.S. Cl. 137/179

(57) ABSTRACT

A float valve assembly includes an outlet, a float and a stopper attached to the float. The stopper opens and closes the outlet based on the movement of the float. When the float moves vertically upward, the stopper moves horizontally away from the outlet to open the outlet and allow fluid flow out of the outlet. When the float moves vertically downward, the stopper moves horizontally towards the outlet to close the outlet. Thus, the direction of movement of the stopper is generally perpendicular to the direction of the buoyant and gravitational forces acting on the float. The float valve can be used in an oil separator/filter. The float may be formed of an elastomeric material and the stopper may be a seating needle or other stopper.

This application claims the benefit of U.S. Provisional Application No. 60/572,626 filed May 19, 2004, entitled “Float Valve Assembly,” the disclosure of which also is entirely incorporated herein by reference.

### TECHNICAL FIELD

The present subject matter relates to a device for managing and controlling pressurized fluid flow. More specifically, the present subject matter relates to a new and improved float valve assembly for an oil separator/filter.

### BACKGROUND

Floats are usually spherical, hollow, and made of steel in order to withstand pressure, yet be light enough to enable buoyancy. Float assembly valves for oil separators/filters are typically provided such that the seating needle of the oil drain outlet moves parallel to the direction of the buoyant movement of the float. This configuration requires relatively large diameter vessels, resulting in bulky float assembly valves and inefficient oil level regulation.

### SUMMARY

There is provided a device for managing and controlling fluid flow. Specifically provided is a float valve assembly for an oil separator/filter. In the device of the present subject matter, oil laden gaseous refrigerant or air enters the device through an inlet port. A filter element separates the oil from the gas while particulate contaminants are captured on the inner surface of the filter element. The oil-free and dirt-free refrigerant gas exits the device via an outlet.

During the separation and filtration process, oil droplets form along the inner surface of the filter element. The oil droplets grow in mass as they make their way to the outer boundary of the filter element. After making their way to the outer surface of the filter element, the oil droplets fall to the bottom of the device. The oil then collects at the bottom of the device where the float valve assembly is located.

The float valve assembly includes a low density (solid or hollow), high strength float, attached to a float arm. The float arm controls the position of a seating needle, which in turn opens and closes an oil drain outlet at the bottom of the device. As the oil level rises in the bottom of the device, the buoyancy force of the float, in combination with the mechanical advantage of the float arm, increases until the combination overcomes the summation of forces resulting from internal pressure and the float mechanism's weight. When this occurs, the seating needle opens the oil drain outlet and allows oil to flow out of the device.

The present subject matter provides an improved float valve assembly.

The present subject matter also provides a reduced size float valve assembly for an oil separator/filter.

The present subject matter further provides a more efficient float valve assembly.

The present subject matter provides a float valve geometry that enables a greater mechanical advantage.

The present subject matter provides a float material that results in a greater buoyant force.

The present subject matter provides a float geometry that results in a higher pressure rating.

Additionally, the present subject matter provides a float valve assembly wherein the seating needle moves perpendicular to the buoyant movement of the float.

Moreover, the present subject matter provides a float valve assembly wherein flow occurs when the internal pressure and the float mechanism's weight are overcome.

Additional objects, advantages and novel features of the examples will be set forth in part in the description which follows, and in part will become apparent to those skilled in the art upon examination of the following and the accompanying drawings or may be learned by production or operation of the examples. The objects and advantages of the concepts may be realized and attained by means of the methodologies, instrumentalities and combinations of the present disclosure.

### BRIEF DESCRIPTION OF DRAWINGS

FIG. 1 is a cross-sectional view of a float valve assembly for an oil separator/filter of the present subject matter.

### DETAILED DESCRIPTION

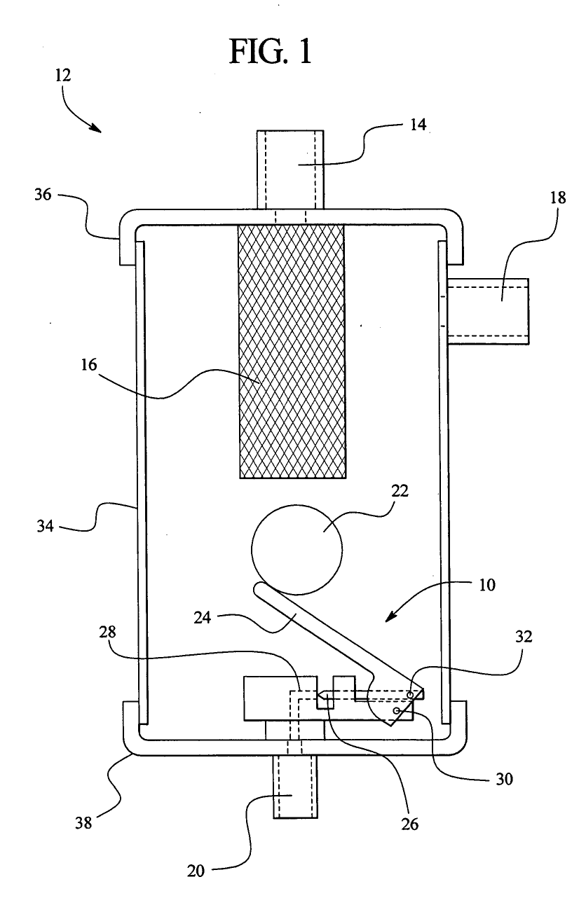

The present subject matter discloses a float valve assembly for an oil separator/filter. One embodiment of a float valve assembly 10 for an oil separator/filter 12 is shown in FIG. 1. As shown in FIG. 1, the oil separator/filter 12 includes an inlet 14 for oil and contaminant laden air or refrigerant gas. The inlet 14 is attached to, or integral with, a top cap 36. The top cap 36 is attached to, or integral with, a shell 34. A first outlet 18 is attached to the shell 34. A bottom cap 38 is attached to, or integral with, the shell 34. A second outlet 20 is attached to, or integral with, the bottom cap 38. In the embodiment shown in FIG. 1, the shell 34, the top cap 36 and the bottom cap 38 comprise a housing. However, it is contemplated the housing may include greater or fewer elements and may be another shape and/or proportion. Further it is understood that the second outlet 20 may alternatively be located along the side of the housing, rather than the bottom as shown in FIG. 1. The oil separator/filter 12 also includes a filter 16. In the embodiment shown in FIG. 1, the filter 16 is secured to a filter stud by a lock nut (not shown). An O-ring seal (not shown) is employed at the interface between the filter 16 and the wall of the oil separator/filter 12 to ensure the incoming gas passes through the filter 16. However, the filter 16 may be otherwise configured to filter the material passing into the oil separator/filter 12, as discussed further below.

In use, oil laden gaseous refrigerant or air enters the oil separator/filter 12 through the inlet 14. The filter 16 separates the oil from the gas while particulate contaminants are captured on the inner surface of the filter 16. The oil separator/filter 12 prevents oil and particulate contaminants from entering the refrigeration system's evaporator, attached to the first outlet 18, which would decrease the heat transfer efficiency and cause an increase in power consumption. The oil separator/filter 12 prevents particulate contaminants and gaseous or liquid refrigerant from entering the compressor crankcase and damaging the compressor. Further, the oil separator/filter 12 regulates the return of particulate free oil to the compressor for necessary lubrication of moving parts. The oil-free and dirt-free gas exits the oil separator/filter 12 via the first outlet 18, as further shown in FIG. 1.

During the filtration of the gas, oil droplets form along the inner surface of the filter 16. The oil droplets grow in mass as they make their way to the outer boundary of the filter 16. After making their way to the outer surface of the filter 16, the oil droplets fall to the bottom of the oil separator/filter 12. The oil then collects at the bottom of the oil separator/filter 12 where the float valve assembly 10 is located.

As shown in FIG. 1, the float valve assembly 10 includes a float 22 made from low density, high strength material attached to a float arm 24. The float 22 may be secured to the float arm 24. For example, the float 22 may be secured to the float arm 24 by a fastening screw. The float 22 may be formed from the elastomeric material sold by the Rogers Corporation under the trademark nitrophyl®. Alternatively, the float 22 may be formed from another low density, high strength material. For example, the float 22 may be hollow and made from steel or another high-strength material. It is appreciated that while the float 22 shown in FIG. 1 is illustrated and described as being spherical, the float 22 may instead be formed in other geometric configurations without departing from the scope of the present subject matter. For example, the cross-section of the float 22 shown in FIG. 1 may be a square, an oval, may incorporate tapered, beveled, cylindrical or non-cylindrical sections.

In the embodiment shown FIG. 1, the float arm 24 controls the position of a seating needle 26, within a needle guide bore 28 of the second outlet 20. The position of the seating needle 26 within the needle guide bore 28 opens and closes the second outlet 20 and controls the outflow of the oil that collects at the bottom of the oil separator/filter 12. The needle guide bore 28 may be formed integral with the outlet 20 or may be a separate element attached to the outlet 20 or the housing. The float arm 24 is attached to the seating needle 26 via a first pin 30 and a second pin 32, as shown in FIG. 1. The first pin 30 provides an axis about which the float arm 24 rotates. The second pin 32 connects the float arm 24 to the seating needle 26. Thus, the combination of the first pin 30 and the second pin 32 operates as a lever arm for moving the seating needle 26 generally horizontally as the float arm 24 rotates about first pin 30. As the seating needle 26 translates horizontally, the rotation of the second pin 32 around the first pin 30 causes the seating needle 28 to tilt out of the horizontal plane. Thus, the needle guide bore 28 is adapted to allow movement of the seating needle 26 out of the horizontal plane within an expected range of motion. It is contemplated that the seating needle 26 shown in FIG. 1 is merely one example of a stopper that may be employed in the float valve assembly 10 to open and close the second outlet 20. For example, in the embodiment shown in FIG. 1, the travel of the float arm 24 will stop when the seating needle 26 contacts the side wall of the guide bore 28. Alternatively, the travel of the float arm 24 may be stopped when the float 22 contacts the shell 34 or a stop (not shown) or when the end of the seating needle 26 contacts a stop (not shown). Further, a natural or synthetic rubber plunger or other type of stopper may be used in place of the seating needle 26. Moreover, needle guide bore 28 may be eliminated and the stopper may seat around the orifice of the outlet 20, rather than within the needle guide bore 28.

As shown in FIG. 1, as the oil level rises in the bottom of the oil separator/filter 12, the buoyancy force of the float 22, in combination with the mechanical advantage of the float arm 24, increases until the combination overcomes the summation of forces resulting from internal pressure and the float mechanism's weight. When this occurs, the seating needle 26 opens the second outlet 20 and allows oil to flow out of the oil separator/filter 12.

As demonstrated in FIG. 1, providing a seating needle 26 or other stopper that moves perpendicular to the direction of the buoyant movement of the float 22 enables the needle guide bore 28, the needle 26, the first pin 30 and the second pin 32 to be located below the float 22 instead of along side it. This configuration allows for the use of a larger float 22 and increases the mechanical advantage of the float valve assembly 10 for a given housing size. Thus, the float valve assembly 10 and the oil separator/filter 12 disclosed herein benefits from being more compact than previous oil separator/filters having float valve assemblies.

While the foregoing has described what are considered to be the best mode and/or other examples, it is understood that various modifications may be made therein and that the technology and subject matter disclosed herein may be implemented in various forms and examples, and that they may be applied in numerous applications, only some of which have been described herein. Those skilled in that art will recognize that the disclosed aspects may be altered or amended without departing from the true spirit and scope of the subject matter. Therefore, the subject matter is not limited to the specific details, dimensions, representative devices, and illustrated examples in this description. It is intended to protect any and all modifications and variations that fall within the true scope of the advantageous concepts disclosed herein.

1. An oil separator/filter comprising:
a housing including an inlet, a first outlet and a second outlet, wherein said second outlet includes a needle guide bore;
a float arm including a pivot axis located along a first end of said float arm;
a float secured along a second end of said float arm; and
a seating needle pivotally secured along said first end of said float arm such that when increasing buoyant forces overcome gravitational forces and forces due to internal pressure said float rotates said float arm around said pivot axis to withdraw said seating needle from said needle guide bore to open said second outlet enabling oil to flow out of said housing, wherein the direction of translation of said seating needle is generally perpendicular to the direction of the buoyant and gravitational forces acting upon said float.

2. The oil separator/filter of claim 1 further comprising a filter element adjacent to said inlet.

3. The oil separator/filter of claim 1 wherein said first outlet is a gas outlet and said second outlet is an oil drain outlet.

4. The oil separator/filter of claim 1 wherein said float is cylindrical.

5. The oil separator/filter of claim 1 wherein said float is spherical.

6. The oil separator/filter of claim 1 wherein said float comprises an elastomeric material.

7. The oil separator/filter of claim 1 wherein said float comprises steel.

8. The oil separator/filter of claim 1 wherein said pivot axis is defined by a pin inserted through said float arm.

9. A float valve assembly comprising:
an outlet including a needle guide bore;
a float arm including a pivot axis located along a first end of said float arm;
a float secured along a second end of said float arm; and
a seating needle pivotally secured along said first end of said float arm such that when increasing buoyant forces overcome gravitational forces and forces due to internal pressure said float rotates said float arm around said pivot axis to withdraw said seating needle from said needle guide bore to open said second outlet enabling oil to flow out of said housing, wherein the direction of translation of said seating needle is generally perpendicular to the direction of the buoyant and gravitational forces acting upon said float.

10. The float valve assembly of claim 9 wherein said float is spherical.

11. The float valve assembly of claim 9 wherein said float comprises an elastomeric material.

12. The float valve assembly of claim 9 wherein said float valve assembly is part of an oil separator/filter.

13. A float valve assembly comprising:
a housing including an outlet;
a float; and
a stopper attached to said float such that said stopper translates to open and close said outlet, wherein the direction of translation of said stopper is generally perpendicular to the direction of the buoyant and gravitational forces acting upon said float, further wherein when said outlet is open fluid flows out of said housing to decrease the buoyant force acting upon said float.

14. The float valve assembly of claim 13 wherein said float is spherical.

15. The float valve assembly of claim 13 wherein said float comprises an elastomeric material.

16. The float valve assembly of claim 13 wherein said float valve assembly is part of an oil separator/filter.

17. The float valve assembly of claim 13 wherein said stopper is a seating needle.

18. The float valve assembly of claim 13 wherein said stopper closes said outlet by seating around an orifice located in said outlet.

19. The float valve assembly of claim 13 wherein said stopper is attached to said float by a float arm.

20. The float valve assembly of claim 19 wherein movement of said float causes said float arm to pivot around a pivot axis causing translation of said stopper.
